(19) United States
(12) Patent Application Publication
(10) Pub. No.: US 2012/0204534 A1
(43) Pub. Date: Aug. 16, 2012

(54) SYSTEM AND METHOD FOR DAMPING PRESSURE OSCILLATIONS WITHIN A PULSE DETONATION ENGINE

(75) Inventors: Ross Hartley Kenyon, Waterford, NY (US); Narendra Digamber Joshi, Niskayuna, NY (US); Aaron Jerome Glaser, Niskayuna, NY (US)

(73) Assignee: General Electric Company, Schenectady, NY (US)

(21) Appl. No.: 13/028,099

(22) Filed: Feb. 15, 2011

(51) Int. Cl. B64G 1/40; F02K 7/02

(52) U.S. Cl. 60/204; 60/249

(57) ABSTRACT

In one embodiment, a pulse detonation engine includes a resonator configured to fluidly couple to an air flow path upstream of a pulse detonation tube. The pulse detonation engine also includes a controller configured to receive signals indicative of an operating frequency of an air valve disposed at an upstream end of the pulse detonation tube, and to adjust a geometric configuration of the resonator in response to the signals.

### BACKGROUND OF THE INVENTION

The subject matter disclosed herein relates to a pulse detonation engine and, more specifically, to enhancing the durability and performance of the pulse detonation engine by employing a system and method for damping pressure oscillations.

Pulse detonation combustion can be utilized in various practical engine applications. An example of such an application is the development of a pulse detonation engine (PDE) where hot detonation products are directed through an exit nozzle to generate thrust for aerospace propulsion. Pulse detonation engines that include multiple combustor chambers are sometimes referred to as a “multi-tube” configuration for a pulse detonation engine. Another example is the development of a “hybrid” engine that uses both conventional gas turbine engine technology and pulse detonation (PD) technology to enhance operational efficiency. Such pulse detonation turbine engines (PDTE) can be used for aircraft propulsion or as a means to generate power in ground-based power generation systems.

Within a pulse detonation tube, the combustion reaction is a detonation wave that moves at supersonic speed, thereby increasing the efficiency of the combustion process as compared to subsonic deflagration combustion. Specifically, air and fuel are typically injected into the pulse detonation tube in discrete pulses. The fuel-air mixture is then detonated by an ignition source, thereby establishing a detonation wave that propagates downstream through the tube at a supersonic velocity. In addition, a weaker shock wave may propagate upstream toward the combustor inlet. The detonation process produces pressurized exhaust gas within the pulse detonation tube that may be used to produce thrust or be converted to work in a turbine.

In certain pulse detonation tubes, an air valve is disposed at an upstream end of the tube and configured to emanate air pulses in a downstream direction. Specifically, the air valve is configured to transition to an open position to facilitate air flow into the pulse detonation tube, and to transition to a closed position for the detonation reaction. As previously discussed, the detonation reaction may generate a shock wave that propagates in the upstream direction toward the air valve. Unfortunately, the impact of the shock wave upon the air valve may generate a pressure wave that propagates upstream toward a compressor configured to provide the air flow to the pulse detonation tube. The pressure wave may interfere with air flow through the compressor, thereby decreasing compressor efficiency and/or inducing stall.

Furthermore, additional pressure fluctuations may be induced by the periodic movement of the air valve. For example, when the air valve is in the open position, air flow from the compressor will flow into the pulse detonation tube. However, when the air valve is in the closed position, air pressure may build within a plenum that fluidly couples the compressor to the pulse detonation tube. The periodic variations in air pressure within the plenum may further interfere with air flow through the compressor, thereby increasing the possibility of compressor stall.

### BRIEF DESCRIPTION OF THE INVENTION

In one embodiment, a pulse detonation engine includes a resonator configured to fluidly couple to an air flow path upstream of a pulse detonation tube. The pulse detonation engine also includes a controller configured to receive first signals indicative of an operating frequency of an air valve disposed at an upstream end of the pulse detonation tube, and to adjust a geometric configuration of the resonator in response to the first signals.

In another embodiment, a pulse detonation engine includes a compressor, a turbine, and a pulse detonation tube disposed downstream from the compressor and upstream of the turbine. The pulse detonation tube includes an air valve disposed at an upstream end of the pulse detonation tube. The pulse detonation engine also includes a plenum configured to transfer an air flow from the compressor to the pulse detonation tube, and a resonator fluidly coupled to the plenum. The pulse detonation engine further includes a controller configured to receive first signals indicative of an operating frequency of the air valve, and to adjust a geometric configuration of the resonator in response to the first signals.

In a further embodiment, a method includes receiving first signals indicative of an operating frequency of an air valve disposed at an upstream end of a pulse detonation tube. The method also includes adjusting a geometric configuration of a resonator fluidly coupled to an air flow path upstream of the pulse detonation tube in response to the first signals.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary gas turbine system including a resonator configured to damp pressure oscillations within an air flow path upstream of a pulse detonation tube;

FIG. 2 is a schematic diagram of an embodiment of a pulse detonation combustor that may be used within the gas turbine system of FIG. 1, including a Helmholtz resonator coupled to the air flow path;

FIG. 3 is a schematic diagram of an alternative embodiment of a pulse detonation combustor that may be used within the gas turbine system of FIG. 1, including multiple quarter wave resonators coupled to the air flow path; and

FIG. 4 is a flow diagram of an exemplary method for adjusting a geometric configuration of a resonator fluidly coupled to an air flow path upstream of a pulse detonation tube.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As used herein, a pulse detonation tube is understood to mean any device or system that produces both a pressure rise and velocity increase from a series of repeated detonations or quasi-detonations within the tube. A “quasi-detonation” is a supersonic turbulent combustion process that produces a pressure rise and velocity increase higher than the pressure rise and velocity increase produced by a deflagration wave. Embodiments of pulse detonation tubes include a means of igniting a fuel/oxidizer mixture, for example a fuel/air mixture, and a detonation chamber, in which pressure wave fronts initiated by the ignition process coalesce to produce a detonation wave or quasi-detonation. Each detonation or quasi-detonation is initiated either by external ignition, such as spark discharge or laser pulse, or by gas dynamic processes, such as shock focusing, auto ignition or by another detonation (i.e. cross-fire). As used herein, detonation is used to mean either a detonation or quasi-detonation.

Embodiments disclosed herein may increase compressor efficiency and/or substantially reduce or eliminate the possibility of compressor stall within a pulse detonation engine (PDE) by providing a resonator configured to damp pressure oscillations within an air flow path upstream of a pulse detonation tube. In one embodiment, a PDE includes a compressor, a turbine, and a pulse detonation tube disposed downstream from the compressor and upstream of the turbine. The pulse detonation tube includes an air valve disposed at an upstream end of the pulse detonation tube. The air valve is configured to inject discrete air pulses into the pulse detonation tube to facilitate formation of detonation waves. The PDE also includes a plenum configured to transfer an air flow from the compressor to the pulse detonation tube, and a resonator fluidly coupled to the plenum. The PDE further includes a controller configured to receive first signals indicative of an operating frequency of the air valve, and to adjust a geometric configuration of the resonator in response to the first signals. As will be appreciated, dominant air pressure frequencies within the plenum may be at least partially dependent on the operating frequency of the air valve. Consequently, the controller may be configured to tune the resonator to the dominant air pressure frequencies, thereby damping air pressure oscillations downstream from the compressor. As a result, compressor efficiency may be enhanced and/or the possibility of compressor stall may be substantially reduced or eliminated.

In further embodiments, the PDE may include multiple pulse detonation tubes. In such embodiments, the controller may be configured to receive second signals indicative of a firing pattern of the pulse detonation tubes, and to adjust the geometric configuration of the resonator based on the first signals and the second signals. In addition, the PDE may include a sensor fluidly coupled to the plenum and configured to output third signals indicative of a temperature, a pressure and/or a ratio of specific heats to the controller. The controller, in turn, may be configured to tune the resonator based on the first signals, the second signals and/or the third signals. Such embodiments may also include a valve configured to exhaust air from the plenum if the sensor detects a pressure fluctuation magnitude that exceeds a threshold value. In this manner, the possibility of excessive pressure oscillations inducing a compressor stall may be further reduced or eliminated. In addition, certain embodiments may include multiple geometrically adjustable resonators to damp multiple pressure oscillation frequencies within the plenum. As a result, secondary harmonic oscillations and/or multiple dominant frequencies may be substantially reduced, thereby further enhancing compressor efficiency.

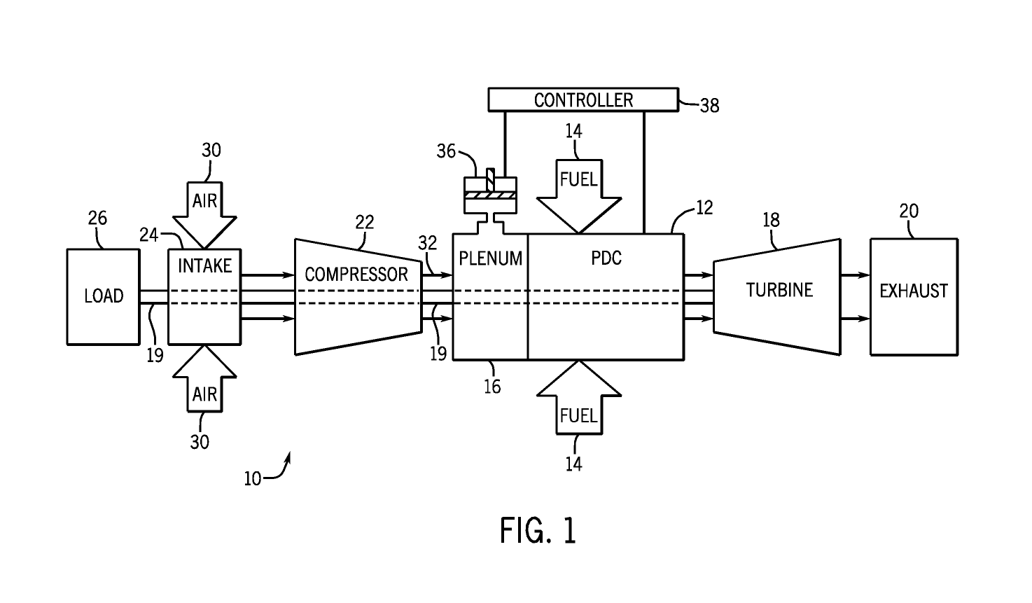

Turning now to the drawings, FIG. 1 is a block diagram of an exemplary gas turbine system 10 including a resonator configured to damp pressure oscillations within an air flow path upstream of a pulse detonation tube. As illustrated, the turbine system 10 includes a pulse detonation combustor (PDC) 12 configured to combust a mixture of fuel and air within at least one pulse detonation tube. A fuel supply 14 routes a liquid fuel and/or gaseous fuel, such as jet fuel or natural gas, to the PDC 12. As discussed below, the PDC 12 includes a plenum 16 configured to receive a flow of air, and to route the air to the pulse detonation tube. The PDC 12 then ignites and combusts the fuel-air mixture via a series of detonation reactions, and passes hot pressurized exhaust gas into a turbine 18. As will be appreciated, the turbine 18 includes one or more stators having fixed vanes or blades, and one or more rotors having blades which rotate relative to the stators. The hot gas stream passes through the turbine rotor blades, thereby driving the turbine rotor to rotate. Coupling between the turbine rotor and a shaft 19 will cause the rotation of the shaft 19, which is also coupled to several components throughout the gas turbine system 10, as illustrated. Eventually, the gas stream may exit the gas turbine system 10 via an exhaust outlet 20.

A compressor 22 includes blades rigidly mounted to a rotor which is driven to rotate by the shaft 19. As air passes through the rotating blades, air pressure increases, thereby providing the PDC 12 with sufficient air for proper combustion. The compressor 22 may intake air to the turbine system 10 via an air intake 24. Further, the shaft 19 may be coupled to a load 26, which may be powered via rotation of the shaft 19. As will be appreciated, the load 26 may be any suitable device that may use the power of the rotational output of the turbine system 10, such as an electrical generator or an external mechanical load. For example, the load 26 may include an electrical generator, a propeller of an airplane, and so forth. The air intake 24 draws air 30 into the turbine system 10 via a suitable mechanism, such as a cold air intake. The air 30 then flows through blades of the compressor 22, which provides compressed air 32 to the PDC 12 via the plenum 16.

As discussed in detail below, the pulse detonation tube within the PDC 12 is configured to receive compressed air 32 and fuel 14 in discrete pulses. After the pulse detonation tube has been loaded with a fuel-air mixture, the mixture is detonated by an ignition source, thereby establishing a detonation wave that propagates through the tube at a supersonic velocity. The detonation process produces pressurized exhaust gas within the pulse detonation tube that ultimately drives the turbine 18 to rotate. Unfortunately, the detonation process may also induce air pressure oscillations within the plenum 16. These pressure oscillations may decrease compressor efficiency and/or increase the possibility of compressor stall. Consequently, the illustrated embodiment includes a resonator assembly 36 fluidly coupled to the plenum 16 and configured to damp the pressure oscillations. In addition, the illustrated embodiment includes a controller 38 communicatively coupled to the resonator assembly 36 and configured to adjust a geometric configuration of a resonator within the assembly. For example, a dominant frequency of air pressure fluctuations within the plenum may be at least partially dependent on an operating frequency of an air valve configured to provide the pulse detonation tube with air pulses. Consequently, the controller 38 may receive signals indicative of the air valve operating frequency, and then adjust the geometric configuration of the resonator based on the signals. By tuning a resonant frequency of the resonator to the dominant frequency within the plenum, air pressure oscillations may be substantially reduced, thereby enhancing compressor efficiency and/or substantially reducing or eliminating the possibility of compressor stall.

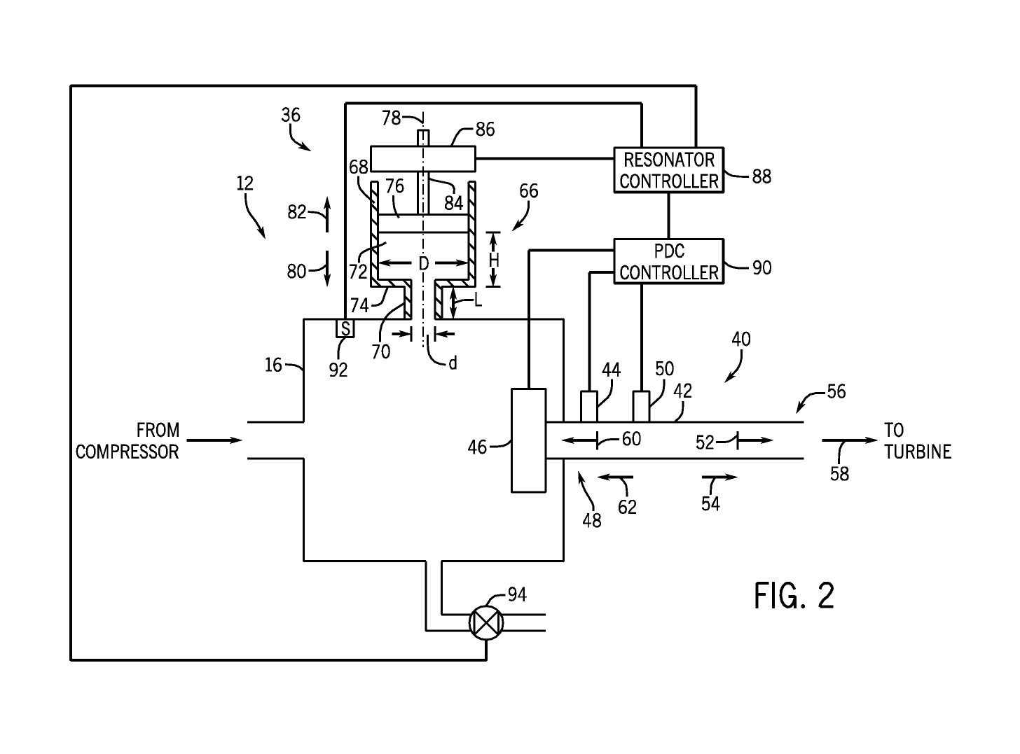

FIG. 2 is a schematic diagram of an embodiment of a pulse detonation combustor 12 that may be used within the gas turbine system 10 of FIG. 1, including a Helmholtz resonator coupled to an air flow path of the pulse detonation combustor. In the illustrated embodiment, the pulse detonation combustor 12 includes a pulse detonation tube 40 having a base tube 42 configured to facilitate propagation of detonation waves. The pulse detonation tube 40 also includes at least one fuel injector 44 (e.g., 1, 2, 3, 4, 5, 6, 7, 8, 9, 10, or more), which feeds fuel to a combustion zone located within the pulse detonation tube 40. Furthermore, the pulse detonation tube 40 includes an air valve 46 disposed to an upstream region 48 of the tube 40. The air valve 46 is configured to inject discrete air pulses into the pulse detonation tube 40. The fuel injector 44 is configured to inject fuel into each of the air pulses to establish a fuel-air mixture suitable for detonation. An ignition source 50 then detonates the fuel-air mixture, thereby forming a detonation wave 52 that propagates through the pulse detonation tube 40 in a downstream direction 54. Specifically, the detonation wave 52 passes through a downstream region 56 of the tube 40, e.g., a region downstream from the ignition source 50. Exhaust gas 58 from the detonation reaction exits the pulse detonation tube 40 in the downstream direction 54 and may be utilized to produce thrust or to drive a turbine, for example.

In addition to forming the detonation wave 52, the detonation reaction may generate a weaker shock wave 60 that propagates in an upstream direction 62 toward the air valve 46. The impact of the shock wave 60 upon the air valve 46 may generate a pressure wave that propagates upstream toward the compressor 22. For example, in the illustrated embodiment, the PDC 12 includes a plenum 16 configured to serve as an air flow path between the compressor 22 and the pulse detonation tube 40. The impact of the shock wave 60 upon the air valve 46 may generate a pressure wave that bypasses the valve 46 and enters the plenum 16. As will be appreciated, the pulse detonation tube 40 may fire (i.e., generate a detonation reaction) at a frequency of about 1 to 1000 Hz, about 5 to 500 Hz, or about 10 to 100 Hz, for example. Consequently, the pressure waves emanating from the pulse detonation tube 40 may induce a pressure oscillation within the plenum 16 having a dominant frequency substantially similar to the firing frequency of the tube 40, and the corresponding operating frequency of the air valve 46. The resultant pressure oscillations may interfere with air flow through the compressor 22, thereby decreasing compressor efficiency and/or increasing the possibility of compressor stall.

Furthermore, additional pressure fluctuations may be induced by the periodic movement of the air valve 46. For example, when the air valve 46 is in the open position, air flow from the compressor 22 will flow into the pulse detonation tube 40. However, when the air valve 46 is in the closed position, air pressure within the plenum 16 may increase. The periodic variations in air pressure within the plenum 16 may further interfere with air flow through the compressor 22, thereby increasing the possibility of compressor stall. Consequently, the illustrated embodiment includes a resonator configured to damp pressure oscillations within the plenum 16, thereby enhancing compressor efficiency and/or substantially reducing or eliminating the possibility of compressor stall.

In the illustrated embodiment, the resonator assembly 36 includes a single resonator 66. As will be appreciated, a resonator is an acoustical chamber that induces a pressurized fluid, such as air, to oscillate at a particular frequency. The frequency of oscillation is at least partially dependent on the geometric configuration of the resonator. For example, if air pressure is fluctuating due to the influence of an external force, a resonator, tuned to the frequency of these fluctuations, may damp the fluctuation magnitude. A Helmholtz resonator, such as the resonator 66 employed in the illustrated embodiment, includes a body and a throat having a smaller diameter than the body. Pressurized air entering the throat is collected in the body until the pressure within the body becomes greater than the external air pressure. At that point, the air within the body will exit the throat, thereby reducing the pressure within the body. The lower body pressure induces the external air to enter the body, where the process repeats. The cyclic movement of air establishes a resonant frequency that may damp a corresponding frequency within the plenum 16.

In the illustrated embodiment, the resonator 66 is a cylindrical Helmholtz resonator, including a body 68 and a throat 70. A volume 72 is defined by the resonator body 68, a base member 74 and a piston 76 inserted into an open end of the resonator body 68. As will be appreciated, the resonant frequency of a Helmholtz resonator is at least partially dependent on the geometric configuration of the resonator. For example, a cylindrical Helmholtz resonator produces a resonant frequency based on the following equation:

$$f = \frac{c}{2 π} \sqrt{\frac{{d}^{2}}{{LHD}^{2}}}$$

where c is the speed of sound through the fluid (e.g., air), d is the diameter of the throat 70, L is the length of the throat 70, H is the distance between the piston 76 and the base member 74 of the resonator body 68, and D is the diameter of the resonator body 68. In the illustrated embodiment, the throat diameter d, the throat length L and the resonator body diameter D are fixed. Therefore, the resonant frequency f of the resonator 66 may be adjusted by altering the height H. The height H may be decreased by translating the piston 76 along an axis 78 in a direction 80 toward the base member 74. Conversely, the height H may be increased by translating the piston 76 in a direction 82 along the axis 78 away from the base member 74. In this manner, the resonant frequency f may be adjusted to any frequency within the geometric constraints of the resonator 66.

In the illustrated embodiment, the piston 76 is coupled to a shaft 84 which passes through a piston driver 86. The piston driver 86 may be any form of linear actuator capable of translating the piston 76 via the shaft 84. For example, the shaft 84 may include a rack with teeth configured to interlock with respective teeth of a pinion within the driver 86. The pinion may be coupled to an electric motor, for example, configured to rotate the pinion based on controller input. As the pinion rotates, the piston 76 will be linearly driven by the rack of the shaft 84. Other linear actuators (e.g., screw drive, pneumatic, hydraulic, electromechanical, etc.) may be employed in alternative embodiments.

Tuning the resonator 66 to a dominant frequency within the plenum 16 may reduce pressure oscillations downstream from the compressor 22, thereby increasing compressor efficiency and/or substantially reducing or eliminating the possibility of stall. In the illustrated embodiment, the piston driver 86 is communicatively coupled to a resonator controller 88. The resonator controller 88 is configured to adjust the geometric configuration of the resonator 66 such that the resonant frequency substantially matches a dominant frequency within the plenum 16. As will be appreciated, the resonator controller 88 may determine the dominant frequency within the plenum 16 by direct measurement, or via computation based on air valve operating frequency. As previously discussed, the air valve operating frequency may determine the rate at which pressure waves enter the plenum 16 and/or the periodic variations in air pressure associated with valve cycling. Consequently, the resonator controller 88 may be configured to tune the resonator 66 to a frequency that substantially matches the operating frequency of the air valve 46, thereby damping pressure oscillations within the plenum 16.

In the illustrated embodiment, the pulse detonation tube 40 is controlled by a PDC controller 90. The PDC controller 90 is communicatively coupled to the fuel injector 44, the air valve 46 and the ignition source 50. Consequently, the PDC controller 90 may adjust the opening frequency and/or opening duration of the air valve 46, the activation frequency and/or injection flow rate of the fuel injector 44, and/or the timing of the ignition source 50 to provide the desired flow of exhaust gas 58 to the turbine 18. In the illustrated embodiment, the PDC controller 90 is also configured to output signals to the resonator controller 88 indicative of the operating frequency of the air valve 46, thereby enabling the resonator controller 88 to effectively tune the resonator 66. While separate controllers 88 and 90 are employed in the illustrated embodiment, it should be appreciated that a single controller, such as the controller 38 described above with reference to FIG. 1, configured to control both the resonator 66 and the pulse detonation tube 40 may be utilized in alternative embodiments.

The resonator controller 88 is also communicatively coupled to a sensor 92 configured to measure a temperature, a pressure and/or a ratio of specific heats of the air within the plenum 16. As will be appreciated, the dominant frequency within the plenum may be at least partially dependent on the temperature, pressure and/or ratio of specific heats. Consequently, the resonator controller 88 may be configured to adjust the geometric configuration of the resonator 66 to account for variations in these parameters, thereby providing effective damping of the pressure oscillations within the plenum 16. For example, the controller 88 may be configured to determine the dominant frequency within the plenum based on signals from the sensor 92 indicative of the pressure oscillation frequency. The resonator controller 88 may then adjust the geometric configuration of the resonator 66 based on the air valve operating frequency and the measured pressure oscillation frequency within the plenum. In addition, the resonator controller 88 is communicatively coupled to a valve 94 configured to exhaust air from the plenum 16 if a magnitude of the pressure oscillations exceeds a threshold value. For example, if the sensor 92 detects variations in pressure greater than the threshold value, the controller 88 may instruct the valve 94 to open, thereby exhausting the air within the plenum 16 and substantially reducing the magnitude of the pressure oscillations. Such an operation may result in deactivation of the turbine system 10 due to reduced air flow to the pulse detonation tube 40. However, if excessive pressure oscillations are detected, exhausting the plenum air will also substantially reduce or eliminate the possibility of compressor stall.

While the illustrated resonator assembly 36 includes a single resonator 66, it should be appreciated that alternative embodiments may include additional resonators. For example, certain embodiments may employ 1, 2, 3, 4, 5, 6, 7, 8, 9, 10, or more resonators, each tuned to a different frequency. The resonators may be positioned at different axial and/or circumferential positions about the plenum 16. In this manner, multiple frequencies may be simultaneously damped. For example, the controller 88 may be configured to determine secondary harmonic frequencies associated with operation of the valve 46. In such a configuration, the controller 88 may tune one resonator to the dominant air valve operating frequency, and the other resonators to various secondary harmonic frequencies. In addition, as discussed in detail below, certain pulse detonation combustors may include multiple pulse detonation tubes 40, thereby generating multiple dominant frequencies based on the operational frequency of each air valve. In such embodiments, the controller 88 may tune each resonator to a respective valve operating frequency, thereby enhancing compressor efficiency and/or substantially reducing or eliminating the possibility of compressor stall.

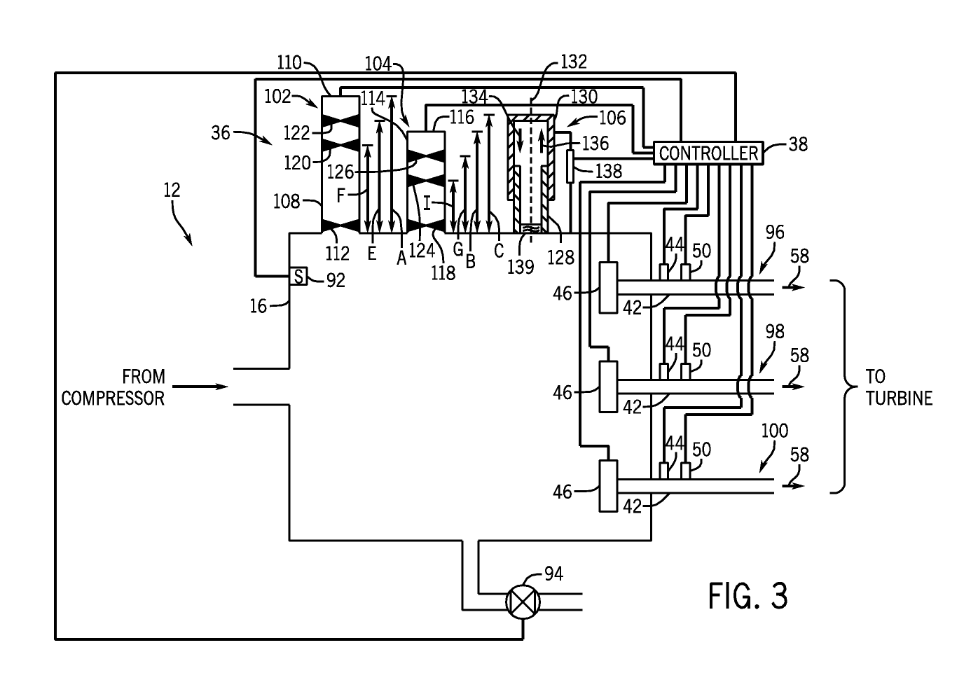

FIG. 3 is a schematic diagram of an alternative embodiment of a pulse detonation combustor that may be used within the gas turbine system 10 of FIG. 1, including multiple quarter wave resonators coupled to a plenum of the pulse detonation combustor. In the illustrated embodiment, the PDC 12 includes a first pulse detonation tube 96, a second pulse detonation tube 98 and a third pulse detonation tube 100. Similar to the PDC controller 90 discussed above with reference to FIG. 2, the controller 38 is communicatively coupled to the air valve 46, the fuel injector 44 and the ignition source 50 of each pulse detonation tube. In the illustrated embodiment, the controller 38 is configured to both control operation of the pulse detonation tubes 96, 98 and 100, and the resonator assembly 36. As will be appreciated, the controller 38 may be configured to adjust a firing pattern of the pulse detonation tubes to achieve a desired flow rate of exhaust gas 58 to the turbine.

The controller 38 may also be configured to adjust the valve opening frequency of each pulse detonation tube to reduce pressure oscillations within the plenum 16. For example, in one embodiment, the controller 38 may be configured to open the air valve 46 of the first tube 96, while the air valves 46 of the second and third tubes 98 and 100 are closed. The controller 38 may then instruct the air valve 46 of the first tube 96 to close and the air valve 46 of the second tube 98 to open at substantially the same time. Finally, the controller 38 may instruct the air valve 46 of the second tube 98 to close and the air valve 46 of the third tube 100 to open at substantially the same time. In this manner, the air flow through the plenum 16 will be substantially constant, thereby substantially reducing pressure oscillations associated with cycling a single valve. As will be appreciated, a similar technique may be employed in pulse detonation combustors having more or fewer pulse detonation tubes. For example, certain embodiments, may include 2, 3, 4, 6, 8, 10, 12, 16, 20, 24, 28, 32, or more pulse detonation tubes. In addition, opening and closing various groups of valves in a similar pattern may provide an effective reduction in pressure oscillations. For example, in certain embodiments, air valves may be opened and closed in pairs to provide a substantially constant flow of air through the plenum 16. By monitoring the operating frequency of each valve, the controller 38 may determine any remaining dominant pressure oscillation frequencies within the plenum 16 and adjust the resonator assembly 36 to damping the oscillations.

In addition, the controller 38 may be configured to monitor the firing pattern of the pulse detonation tubes to facilitate adjustment of the resonator assembly 36. As previously discussed, each detonation reaction will generate a weak shock that may induce formation of a pressure wave within the plenum 16. By monitoring activation of each ignition source 50, the controller 38 may determine dominant and/or secondary harmonic frequencies associated with the firing pattern. Consequently, the controller may be configured to tune the resonator assembly 36 to such frequencies, thereby damping pressure oscillations within the plenum. Furthermore, similar to the embodiment described above with reference to FIG. 2, a sensor 92 may be communicatively coupled to the controller 38 and configured to output signals indicative of temperature, pressure and/or ratio of specific heats of the air within the plenum 16. As a result, the controller 38 may adjust the geometric configuration of one or more resonators within the resonator assembly 36 based on the output signals from the sensor, the firing pattern of the pulse detonation tubes and/or the operating frequency of each air valve.

In the illustrated embodiments, the resonator assembly 36 includes multiple quarter wave resonators, 102, 104 and 106. The first quarter wave resonator 102 includes a tube 108 of height A that terminates in an end cap 110. The first resonator 102 also includes an isolation valve 112 which may open to couple the first resonator 102 to the plenum 16. When the isolation valve 112 is closed, the first resonator 102 is isolated from the plenum 16, thereby effectively uncoupling the first resonator 102 from the plenum 16.

As the name implies, a quarter wave resonator is tuned to a quarter of the wavelength of an acoustical oscillation. Therefore, the resonant frequency of the first quarter wave resonator 102 is as follows:

$$f = \frac{c}{4 A}$$

where c is the speed of sound in the fluid (e.g., air), and A is the height of the resonator 102. Consequently, the first resonator 102 may damp a frequency corresponding to a wavelength four times height A.

Similar to the first resonator 102, the second quarter wave resonator 104 includes a tube 114 terminating in an end cap 116, thereby damp a frequency corresponding to a wavelength four times the height B. The second resonator 104 also includes an isolation valve 118 to facilitate uncoupling the resonator 104 from the plenum 16. As previously discussed, pressure oscillations within the plenum 16 may include multiple dominant frequencies. For example, the plenum 16 may experience pressure oscillations at frequencies corresponding to wavelengths four times greater than height A and four times greater than height B. In such a situation, both isolation valves 112 and 118 may be opened such that the first and second resonators 102 and 104 may damp the oscillations at both frequencies. In other operating conditions, the plenum 16 may only experience oscillations corresponding to a wavelength four times greater than height A. In such situations, the isolation valve 118 may be closed to uncouple the second resonator 104 from the plenum 16.

As previously discussed, the resonant frequency of quarter wave resonators is at least partially dependent on tube length. Therefore, a quarter wave resonator may be tuned by increasing or decreasing the tube length. In the illustrated embodiment, the first and second quarter wave resonators 102 and 104 include a series of valves to adjust the length of the respective tubes. For example, the first resonator 102 includes a lower valve 120 and an upper valve 122. The lower valve 120 is located a height F above the plenum 16, while the upper valve 122 is at a height E. The lower and upper valves 120 and 122 may be selectively opened and closed to adjust the effective length of the first resonator 102. For example, if the lower valve 120 is closed while the upper valve 122 is open, the first resonator 102 will damp oscillations corresponding to a wavelength four times the height F. In addition, if the lower valve 120 is open while the upper valve 122 is closed, the first resonator 102 will damp oscillations corresponding to a wavelength four times the height E. If both the upper and lower valves 120 and 122 are open, the resonator 102 will damp oscillations corresponding to a wavelength four times height A.

Similarly, the second resonator 104 includes a lower valve 124 and an upper valve 126. By selectively opening and closing the lower and upper valves 124 and 126, the effective length of the second quarter wave resonator 104 may be adjusted between lengths B, G and I. In the illustrated embodiment, each valve 112, 118, 120, 122, 124 and 126 is communicatively coupled to the controller 38. Consequently, the controller 38 may selectively open and close valves to damp dominant and/or secondary harmonic frequencies within the plenum 16. For example, the controller 38 may tune the first resonator 102 to a frequency corresponding to a dominant frequency associated with variations in the operating frequency of the air valves 46. In addition, the controller 38 may tune the second resonator 104 to a dominant frequency associated with the pulse detonation tube firing pattern. As a result, the pressure oscillations within the plenum 16 may be reduced, thereby enhancing compressor efficiency and/or substantially reducing or eliminating the possibility of compressor stall. While the first and second resonators 102 and 104 each include two tube length control valves, it should be appreciated that alternative resonators may include more or fewer valves. For example, certain resonators may include 0, 1, 2, 3, 4, 5, 6, 7, 8, 9, 10, or more valves. Furthermore, valve height and/or valve spacing may vary in alternative embodiments. For example, tighter spacing between valves may facilitate enhanced control of the effective tube length.

In addition to the first and second resonators 102 and 104, the illustrated resonator assembly 36 includes a third quarter wave resonator 106 configured to facilitate continuous length adjustment. Specifically, the third resonator 106 includes a base member 128 coupled to the plenum 16, and an adjustable end cap 130 disposed about an open end of the base member 128. The cross section of the base member 128 and the end cap 130 may be circular or polygonal, among other configurations. The outer diameter of the base member 128 may be substantially similar to the inner diameter of the end cap 130 to establish a seal. The seal may substantially block passage of fluid between the base member 128 and the end cap 130, while enabling the end cap 130 to translate with respect to the base member 128.

A height J of the third resonator 106 may be adjusted by translating the end cap 130 along an axis 132. Specifically, if the end cap 130 is translated in a direction 134 along the axis 132, the height J is reduced. Conversely, if the end cap 130 is translated in a direction 136 along the axis 132, the height J is increased. As illustrated, the end cap 130 is coupled to a linear actuator 138 configured to translate the end cap 130 in both directions 134 and 136 along the axis 132. As will be appreciated, the linear actuator 138 may be any suitable actuator type such as pneumatic, hydraulic, or electromechanical, among others. In this configuration, the height J of the third resonator 106 may be adjusted to damp a desired pressure oscillation frequency, thereby increasing compressor efficiency and/or substantially reducing or eliminating the possibility of compressor stall.

Similar to the length control valves of the first and second resonators 102 and 104, the linear actuator 138 is communicatively coupled to the controller 38 and continuously tuned to a frequency that damps oscillations within the plenum 16. While a single continuously variable quarter wave resonator 106 is coupled to the plenum 16 in the illustrated embodiment, it should be appreciated that multiple continuously variable quarter wave resonators may be employed to damp multiple frequencies in alternative embodiments. Furthermore, it should be appreciated that continuously variable quarter wave resonators may be combined with valve-adjustable quarter wave resonators, such as in the illustrated embodiment, and/or non-adjustable quarter wave resonators to damp oscillations of multiple frequencies.

In the illustrated embodiment, the third resonator 106 includes an energy absorbing feature 139 configured to further damp pressure oscillations within the plenum 16. For example, the energy absorbing feature may include a perforated plate positioned at the interface between the resonator 106 and the plenum 16. As air passes through the perforations, energy associated with the pressure oscillations may be dissipated, thereby reducing the magnitude of the oscillations. As a result, the energy absorbing feature 139 may enhance the effectiveness of the resonator 106. While a single energy absorbing feature 139 is employed in the illustrated embodiment, it should be appreciated that alternative embodiments may include additional energy absorbing features to further dissipate the energy associated with the pressure oscillations.

While three quarter wave resonators are employed in the illustrated embodiment, it should be appreciated that other embodiments may include more or fewer resonators (e.g., 1, 2, 4, 5, 6, 7, 8, 9, 10, or more). For example, certain pulse detonation combustors 12 may produce four dominant frequencies within the plenum 16. In such a configuration, four resonators may be coupled to the plenum 16 to damp oscillations at each of the four frequencies. Other pulse detonation combustors 12 may employ two resonators to damp two dominant frequencies. Furthermore, because certain resonators may be decoupled by closing isolation valves, a turbine system that produces two dominant frequencies may include more than two resonators coupled to the plenum 16. In such a configuration, additional frequencies may be damped by opening the isolation valves of the previously uncoupled resonators. In addition, while the illustrated embodiments employs quarter wave resonators, it should be appreciated that other acoustical resonator configurations (e.g., Helmholtz resonators, concentric hole-cavity resonators, etc.) may be utilized, either individually or in combination with the quarter wave resonators, in alternative embodiments.

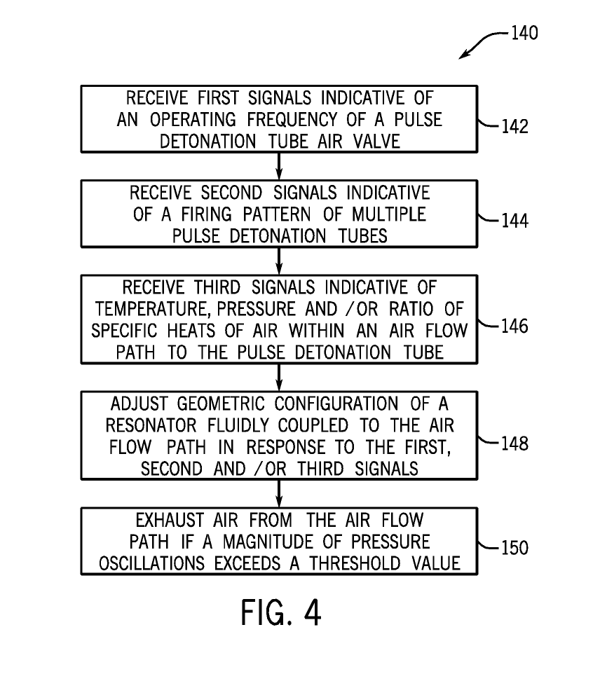

FIG. 4 is a flow diagram of an exemplary method 140 for adjusting a geometric configuration of a resonator fluidly coupled to an air flow path upstream of a pulse detonation tube. First, as represented by block 142, first signals indicative of an operating frequency of an air valve disposed at an upstream end of a pulse detonation tube are received. For example, the PDC controller 90 may output signals to the resonator controller 88 indicative of the valve opening frequency. Next, second signals indicative of a firing pattern of multiple pulse detonation tubes are received, as represented by block 144. For example, the controller may monitor the activation signals to each ignition source of the multiple pulse detonation tubes. Furthermore, third signals indicative of temperature, pressure and/or ratio of specific heats of air within an air flow path to the pulse detonation tube are then received, as represented by block 146. For example, the sensor 92 may monitor the air pressure, temperature and/or ratio of specific heats within the plenum 16, and output signals indicative of these parameters to the controller.

A geometric configuration of a resonator fluidly coupled to the air flow path is then adjusted in response to the first, second and/or third signals, as represented by block 148. For example, a piston within a Helmholtz resonator may be adjusted to tune the resonator to a desired frequency. Similarly, valves within a quarter wave resonator may be selectively opened and closed and/or the length of the quarter wave resonator may be adjusted to achieve a desired resonant frequency. As previously discussed, tuning one or more resonators to dominant and/or secondary harmonic frequencies within the plenum 16 may reduce a magnitude of pressure oscillations, thereby enhancing compressor efficiency and/or substantially reducing or eliminating the possibility of compressor stall. Finally, as represented by block 150, air from the air flow path is exhausted if a magnitude of the pressure oscillations within the plenum exceeds a threshold value. Such an operation may result in deactivation of the turbine system due to reduced air flow to the pulse detonation tube. However, if excessive pressure oscillations are detected, exhausting the plenum air will also substantially reduce or eliminate the possibility of compressor stall.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A pulse detonation engine comprising:
a resonator configured to fluidly couple to an air flow path upstream of a pulse detonation tube; and
a controller configured to receive first signals indicative of an operating frequency of an air valve disposed at an upstream end of the pulse detonation tube, and to adjust a geometric configuration of the resonator in response to the first signals.

2. The pulse detonation engine of claim 1, comprising a plurality of resonators, wherein the controller is configured to adjust a respective geometric configuration of each resonator in response to the first signals.

3. The pulse detonation engine of claim 1, wherein the resonator comprises a Helmholtz resonator or a quarter wave resonator.

4. The pulse detonation engine of claim 1, wherein the controller is configured to exhaust air from the air flow path if a magnitude of pressure oscillations within the air flow path exceeds a threshold valve.

5. The pulse detonation engine of claim 1, comprising an energy absorbing feature in fluid communication with the resonator and configured to damp pressure oscillations within the air flow path.

6. The pulse detonation engine of claim 1, wherein the controller is configured to receive second signals indicative of a firing pattern of a plurality of pulse detonation tubes, and to adjust the geometric configuration of the resonator in response to the first signals and the second signals.

7. The pulse detonation engine of claim 6, comprising a plurality of resonators, wherein the controller is configured to adjust a respective geometric configuration of each resonator in response to the first signals and the second signals.

8. The pulse detonation engine of claim 6, wherein the controller is configured to receive third signals indicative of at least one of a temperature, a pressure, and a ratio of specific heats, of air within the air flow path, and to adjust the geometric configuration of the resonator in response to the first signals, the second signals and the third signals.

9. The pulse detonation engine of claim 1, wherein the controller is configured to receive second signals indicative of at least one of a temperature, a pressure, and a ratio of specific heats, of air within the air flow path, and to adjust the geometric configuration of the resonator in response to the first signals and the second signals.

10. The pulse detonation engine of claim 9, wherein the second signals indicative of pressure comprise a pressure oscillation frequency within the air flow path.

11. A pulse detonation engine comprising:
a compressor;
a turbine;
a pulse detonation tube disposed downstream from the compressor and upstream of the turbine, wherein the pulse detonation tube comprises an air valve disposed at an upstream end of the pulse detonation tube;
a plenum configured to transfer an air flow from the compressor to the pulse detonation tube;
a resonator fluidly coupled to the plenum; and
a controller configured to receive first signals indicative of an operating frequency of the air valve, and to adjust a geometric configuration of the resonator in response to the first signals.

12. The pulse detonation engine of claim 11, comprising a plurality of pulse detonation tubes, wherein the controller is configured to receive second signals indicative of a firing pattern of the plurality of pulse detonation tubes, and to adjust the geometric configuration of the resonator in response to the first signals and the second signals.

13. The pulse detonation engine of claim 12, wherein the controller is configured to receive third signals indicative of at least one of a temperature, a pressure, and a ratio of specific heats, of the air flow within the plenum, and to adjust the geometric configuration of the resonator in response to the first signals, the second signals and the third signals.

14. The pulse detonation engine of claim 12, comprising a plurality of resonators, wherein the controller is configured to adjust a respective geometric configuration of each resonator in response to the first signals and the second signals.

15. The pulse detonation engine of claim 11, comprising an energy absorbing feature in fluid communication with the resonator and configured to damp pressure oscillations within the plenum.

16. A method comprising:
receiving first signals indicative of an operating frequency of an air valve disposed at an upstream end of a pulse detonation tube; and
adjusting a geometric configuration of a resonator fluidly coupled to an air flow path upstream of the pulse detonation tube in response to the first signals.

17. The method of claim 16, comprising:
receiving second signals indicative of a firing pattern of a plurality of pulse detonation tubes; and
adjusting the geometric configuration of the resonator in response to the first signals and the second signals.

18. The method of claim 16, comprising:
receiving second signals indicative of at least one of a temperature, a pressure, and a ratio of specific heats, of air within the air flow path;
and adjusting the geometric configuration of the resonator in response to the first signals and the second signals.

19. The method of claim 16, comprising adjusting a respective geometric configuration of each resonator within a plurality of resonators in response to the first signals.

20. The method of claim 16, comprising exhausting air from the air flow path if a magnitude of pressure oscillations within the air flow path exceeds a threshold valve.
